(19) United States
(12) Patent Application Publication
(10) Pub. No.: US 2019/0031351 A1
(43) Pub. Date: Jan. 31, 2019

(54) Luggage compartment for installation on the fuselage or ceiling in a vehicle, and method for producing a luggage compartment of said type

(71) Applicant: Airbus Operations GmbH, Hamburg (DE)

(72) Inventors: Ingo ROTH, Hamburg (DE); Marc FETTE, Hamburg (DE); Martin HENTSCHEL, Hamburg (DE)

(21) Appl. No.: 16/047,238

(22) Filed: Jul. 27, 2018

(30) Foreign Application Priority Data
Jul. 31, 2017 (DE) 102017117274.2

(51) Int. Cl. B64D 11/00; B32B 27/06; B32B 27/20; B29C 70/42; B29C 65/70; B29C 65/00

(52) U.S. Cl. CPC B64D 11/003; B32B 27/065; B32B 27/20; B29C 70/42; B29C 65/70; B29K 2309/08; B29C 66/7212; B32B 2262/101; B32B 2266/0214; B32B 2605/18; B29C 66/727

(57) ABSTRACT

A luggage compartment for installation on the fuselage or ceiling in a vehicle, in particular aircraft, comprises at least two side walls which are connectable in load-bearing fashion to a primary structure of the vehicle and which have a fiber composite structure. The fiber composite structure is produced from reinforced curable molding compound and has at least one reinforcement element at least partially embedded therein. The luggage compartment furthermore comprises a shell element which is connected to the side walls and which defines at least a part of a stowage space of the luggage compartment.

### CROSS-REFERENCES TO RELATED APPLICATIONS

This application claims the benefit of the German patent application No. 10 2017 117 274.2 filed on Jul. 31, 2017, the entire disclosures of which are incorporated herein by way of reference.

### BACKGROUND OF THE INVENTION

The present invention relates to a luggage compartment for installation on the fuselage or ceiling in a vehicle, in particular, aircraft, and to a method for producing a luggage compartment of this type.

The configurability of passenger cabins is an ever more important demand on passenger aircraft. This should permit individualization and adaptation of passenger cabins to the type of use of the aircraft, for example as a short-haul, medium-haul or long-haul aircraft, and to the passengers to be carried. Depending on the type of use of the passenger aircraft, it is thus sought for, in particular, the arrangement, number and type of different passenger seat rows, such as for example economy, business and first class, and the associated stowage spaces for luggage articles in the passenger cabin, to be as freely configurable as possible.

In modern passenger aircraft, a multiplicity of overhead luggage compartments is provided in order to provide stowage spaces, which overhead luggage compartments are installed along a longitudinal axis of the passenger cabin above passenger seat rows. Such overhead luggage compartments are normally connected to a primary structure of the passenger aircraft and have a complex structure composed of different materials in order to ensure adequate load absorption and transmission. For example, luggage compartments are known, for the production of which firstly various individual components, such as sandwich panels with honeycomb cores, injection-molded parts, inserts and reinforcement elements composed of metal, etc., are manufactured and subsequently connected by means of various joining techniques such as welding, adhesive bonding, screw connection, etc.

### SUMMARY OF THE INVENTION

The invention is based on an object of providing a simply configurable luggage compartment for installation on the fuselage or ceiling in a vehicle, which luggage compartment can be produced with reduced outlay. The invention is furthermore based on an object of specifying a method for producing a luggage compartment of this type.

A luggage compartment for installation on the fuselage or ceiling in a vehicle, in particular, aircraft, comprises at least two side walls which are connectable in load-bearing fashion to a primary structure of the vehicle, and a shell element which is connected to the side walls and which defines at least a part of a stowage space of the luggage compartment. The luggage compartment is preferably provided for installation in a passenger cabin of an aircraft, above passenger seats. The side walls are preferably connected to a frame structure of the aircraft. Alternatively, the side walls may also be connected by means of holder elements to an aircraft skin in the region of thickened skin portions.

The stowage space that is at least partially defined by the shell element is suitable, for example, for accommodating one or more luggage articles or items of equipment, for example, emergency equipment. For the loading and unloading of the stowage space, the shell element is preferably provided with an opening, via which the stowage space of the luggage compartment is accessible to passengers from the passenger cabin. The shell element may furthermore comprise a flap which is movable between a closed position and an open position and which may be provided for opening up and closing off the opening in the shell element. The shell element may at least partially define one or more stowage spaces of the luggage compartment which are accessible from the passenger cabin via one or more openings in the shell element. The stowage space of the luggage compartment may furthermore be delimited by the side walls of the luggage compartment, such that the side walls also partially define the stowage space. The side walls preferably delimit the stowage space in a direction along a longitudinal axis of the aircraft.

The luggage compartment is preferably a luggage compartment referred to as a “fixed bin,” in which an underside of the shell element is rigidly connected to the side walls of the luggage compartment. A luggage compartment of this type has a small number of moving parts, specifically only the flap which is pivotable between a closed position and an open position and is therefore relatively simple to manufacture and install and requires little maintenance. Alternatively, the luggage compartment may be provided as a luggage compartment referred to as a “movable bin,” the shell element of which has an underside which is pivotable relative to the side walls between a closed position and an open position for the purposes of opening up the stowage space.

The side walls of the luggage compartment have a fiber composite structure which is produced from a reinforced curable molding compound and which has a reinforcement element at least partially embedded therein. The reinforcement element is, in this case, preferably connected in positively locking and/or cohesive fashion to the fiber composite structure of the side walls.

In the present case, the expression “reinforced curable molding compound” is to be understood to mean a ready-for-use fiber matrix semifinished part for producing a fiber composite component, in which the reinforcement fibers are present in pre-mixed form in a molding compound. The molding compound has a curable plastic material in an uncured state and is provided, in particular, in the form of a doughy thermoset molding compound. The reinforced curable molding compound is thus a precursor product from which a fiber composite component is produced by curing of the molding compound. This is performed, for example, by virtue of the reinforced curable molding compound being subjected to an extrusion process in which the reinforced curable molding compound is firstly applied into a cavity of an extrusion mold and is subsequently cured, and thereby subjected to primary forming, with an introduction of pressure and/or heat.

By virtue of the fact that the side walls have the fiber composite structure produced from reinforced curable molding compound, it is possible to produce side walls of complex forms with reduced outlay. The use of a fiber composite structure produced from a reinforced curable molding compound furthermore makes it possible, during the process of the production of the side walls, for the reinforcement element to be embedded or inserted therein with reduced outlay. This may be performed, for example, in a process step in which the reinforced curable molding compound is present in a non-cured state. In this way, a secure connection, in particular a cohesive and/or positively locking connection, between the fiber composite structure of the side walls and of the at least one reinforcement element, can be produced in a simple manner. The use of additional joining methods, such as, for example, welding, screw connection, adhesive bonding, etc., for the secure connection of the fiber composite structure of the side walls to the reinforcement elements is thus not necessary which simplifies the process of production of the luggage compartment.

The fiber composite structure of the side walls which is produced from reinforced curable molding compound may comprise reinforcement fibers composed of carbon or glass fibers. The reinforcement fibers are preferably chopped fibers, for example, in the form of carbon or glass long fibers which may have a fiber length between 20 mm and 30 mm and, in particular, a fiber length of approximately 25 mm. The use of chopped fibers permits an inexpensive provision of reinforcement fibers. These may be provided, for example, in the form of reinforcement fibers reused by means of recycling and cut to size. The fiber composite structure of the side walls which is produced from reinforced curable molding compound may furthermore comprise a plastic matrix preferably composed of a thermoset material, in particular, composed of unsaturated polyester resin which comprises, in particular, a flame-retardant additive preferably in the form of aluminum hydroxide or of a liquid flame retardant included in the plastic matrix.

In particular, the fiber composite structure of the side walls may be produced from sheet molding compound (SMC) semifinished parts. An SMC semifinished part is a reinforced curable molding compound which is present in foil form. In other words, SMC semifinished parts form semifinished parts in foil form which are prepared for the further processing and in which reinforcement fibers are present in pre-mixed form in a curable plastic material in a non-cured state. For the production of a fiber composite material by means of SMC semifinished parts, these are firstly cut to size and processed to form the finished component, for example, by means of extrusion. During the extrusion, it is possible in one working step for complex press molds to be filled and for the reinforcement elements to be inserted therein and, in particular, embedded between the foil-like SMC semifinished parts. For example, the reinforcement element may be inserted at least in sections between layers composed of at least one SMC semifinished part. In this way, it is possible to produce side walls with reinforcement elements integrated therein, which reinforcement elements may be provided from different materials. This embodiment of the side walls permits the use of efficient manufacturing methods for the production thereof. Accordingly, curing of side wall semifinished parts may be performed, for example, by means of extrusion which, owing to short curing cycles, for example between 3 and 5 minutes, exhibits high productivity and furthermore requires little reworking.

Alternatively or in addition, the fiber composite structure of the side walls may be produced from bulk molding compound (BMC) semifinished parts. A BMC semifinished part is a reinforced curable molding compound which is present in a doughy form ready for further processing. Alternatively or in addition, the fiber composite structure of the side walls may be produced from a thermoplastic molding compound with long reinforcement fibers.

The at least one reinforcement element at least partially embedded in the fiber composite structure of the side walls is generally a component which serves for force absorption and/or for optimized force guidance within the side wall and thus for preventing stress peaks. The reinforcement element is preferably connectable to the primary structure of the vehicle. For this purpose, the reinforcement element may comprise a first section which is embedded in the fiber composite structure of the side walls, and a second section which is connectable to the primary structure of the vehicle. The first section is preferably of plate-like form and may be arranged within the fiber composite structure, such that the fiber composite structure at least partially encloses the first section. The second section may be provided in the form of a connecting element, for example in the form of a sleeve or receiving opening which is connectable to a complementary connecting element of the primary structure of the vehicle.

Alternatively or in addition, the luggage compartment may comprise a reinforcement element in the form of a stiffening element which serves for increasing the flexural stiffness of the side walls. The stiffening element may, for example, be provided in the form of a foam layer which extends through the fiber composite structure of the side walls and which is preferably composed of a plastic foam. In a further development, the side walls may comprise stiffening ribs which may be formed, in particular, by the fiber composite structure. The stiffening ribs may in this case be extended through by a reinforcement element, in particular, in the form of a foam core. It is thus possible to provide side walls of the luggage compartment which are of sandwich-type design at least in sections.

The at least one reinforcement element may be a component produced from metal or plastic. The reinforcement element is preferably a fiber composite component which is produced from a preform assembled from reinforcement fibers, in particular, from endless fibers. The preform may furthermore have a curable plastic material. The stiffening element preferably has reinforcement fibers which are longer than the reinforcement fibers present in the fiber composite structure of the side walls. The preform may be a preform produced by means of a tailored fiber placement (TFP) method. In the TFP method, reinforcement fibers, in particular, endless fibers, for example in the form of rovings, are sewn onto a base material. The sewn-on fibers are in this case sewn on in the direction of an expected force flow profile through the component. In this way, it is possible to realize complex fiber profiles in the case of which the reinforcement fibers are present in as straight a form as possible (without undulation and fiber twist), are arranged in a loading direction and are subjected to uniform load. Alternatively, the preform may be a preform produced by means of wovens, scrims and/or multiaxial scrims. The processing of such preforms which constitute reinforcement element semifinished parts, may be performed by means of conventional methods, such as, for example, resin injection methods, vacuum foil methods, pressing and extrusion methods, and autoclave methods, etc.

The luggage compartment furthermore comprises the shell element which is connected to the side walls and which defines at least a part of the stowage space. The shell element preferably comprises at least one sandwich panel which is constructed from two surface layers with a core layer arranged in between and which is preferably connected to the at least two side walls. The sandwich panel may form at least a part of a housing of the luggage compartment. In particular, the sandwich panel may form a housing main body which is between the side walls and connected thereto, of the luggage compartment. Alternatively or in addition, the flap which is movable between the closing and opening-up positions, of the shell element, and which may, in particular, be connected to the housing main body of the luggage compartment, may be provided in the form of a sandwich panel.

The core layer of the sandwich panel may be composed of a plastic foam, in particular, of a thermoplastic foam preferably composed of polyetherimide or some other thermoplastic material. For example, the core layer may be composed of the material Dynatech® from the company SMTC which is an expanded polyetherimide foam. The core layer may be applied between the surface layers by means of a foaming method such that this core layer can be arranged directly on and connected to the surface layers. In other words, during the foaming method, in which the core layer is produced between the surface layers, welding of the surface layers to the core layer takes place simultaneously. Furthermore, during the foaming method, welding of the core layer to the side walls may take place if these are arranged in the region of a sandwich panel semifinished part.

The surface layers of the sandwich panel are preferably composed of a fiber-reinforced plastic which may include reinforcement fibers, for example composed of glass, carbon or natural fibers, and/or a plastic matrix composed of a thermoplastic material, in particular, polyetherimide.

In marginal regions of the sandwich panel, in which the core layer is normally exposed, the sandwich panel may comprise an edge structure which encloses or closes off the core layer. In other words, the edge structure prevents the core layer from being exposed in marginal regions of the sandwich panel. The edge structure may, in particular, be formed in those marginal regions of the sandwich panel which are visible to a passenger when the luggage compartment is in an installed state in the vehicle. The edge structure may be formed by at least one of the surface layers. For example, in those marginal regions of the sandwich panel which have the edge structure, a first of the two surface layers may comprise a section which projects beyond the core layer and which forms the edge structure, and which is connected to the second of the two surface layers.

For the connection of the side walls and of the shell element to one another, the side walls comprise, in each case, at least one first interlocking element, and the shell element, in particular, the sandwich panel, comprises at least two second interlocking elements which are complementary to the first interlocking elements and which can, in particular, be latched together with the first interlocking elements. The first and second interlocking elements are preferably provided for the positively locking and/or cohesive connection of the side walls to the shell element. The first interlocking element may be formed on a surface of the side walls which faces toward the shell element, in particular, toward the sandwich panel, preferably along a marginal region of the side walls. In particular, the first interlocking element may be formed by the fiber composite structure of the side walls or of a reinforcement element embedded therein. The second interlocking elements may correspondingly be formed in marginal regions which face toward the side walls, of the sandwich panels. The second interlocking elements may be formed by the sandwich panel and, in particular, by at least one of the surface layers of the sandwich panel.

The combination of the side walls produced from reinforced curable molding compound, in particular, from SMC semifinished parts, with the shell element of sandwich-type design forms a modular concept for the production and configuration of luggage compartments. This modular concept makes it possible for different functionally optimized and complex luggage compartments to be produced in a cost-efficient manner. The components of the luggage compartment can thus be produced with a load-optimized structure, whereby the luggage compartments are lighter and more compact. Even large luggage compartment systems composed of multiple luggage compartments can thus be produced in a flexible and cost-efficient manner.

A method for producing a luggage compartment for installation on the fuselage or ceiling in a vehicle, in particular, aircraft, comprises a step of providing at least two side wall semifinished parts which are composed of a reinforced curable molding compound and which include a curable plastic material in a non-cured state. At least one reinforcement element or at least one reinforcement element semifinished part is inserted in each case into the side wall semifinished parts. The method furthermore comprises a step of curing the curable plastic material included in the side wall semifinished parts in order to produce at least two side walls which are connectable in load-transmitting fashion to a primary structure of the vehicle and which have a fiber composite structure produced from the reinforced curable molding compound, into which fiber composite structure the reinforcement element is at least partially embedded. A connection of the side walls to a shell element which defines at least a part of a stowage space of the luggage compartment is also performed.

The side wall semifinished parts composed of reinforced curable molding compound may comprise reinforcement fibers composed of carbon or glass fibers, in particular, chopped fibers, preferably in the form of carbon or glass long fibers, and comprise a plastic matrix preferably composed of a thermoset material, in particular, composed of unsaturated polyester resin and/or with a flame retardant additive preferably in the form of aluminum hydroxide or of a liquid flame retardant included in the plastic matrix. Preferably, the side wall semifinished parts are provided from SMC semifinished parts, wherein, in particular, the provision of one of the side wall semifinished parts comprises the steps of providing at least one SMC semifinished part and cutting the latter to size. Alternatively, the side wall semifinished parts may be provided from BMC semifinished parts.

The method may furthermore comprise a step of providing the reinforcement element semifinished part, wherein the reinforcement element semifinished part is provided in the form of a preform assembled from reinforcement fibers, in particular by means of a TFP method which preform includes a curable plastic material in a non-cured state. Curing of the plastic material included in the reinforcement element semifinished part in order to produce the reinforcement element may also be performed. The curing of the curable plastic material of the molding compound included in the side wall semifinished parts is preferably performed at the same time as the curing of the curable plastic material included in the reinforcement element semifinished part.

The shell element of the luggage compartment preferably comprises at least one sandwich panel with two surface layers and with a core layer arranged in between. The core layer of the sandwich panel may be composed of a plastic foam, in particular of a thermoplastic foam preferably composed of polyetherimide. The surface layers may be composed of a fiber-reinforced plastic which may include reinforcement fibers, composed, for example, of glass fibers, carbon fibers or natural fibers, and/or a plastic matrix composed of a thermoplastic material, in particular polyetherimide.

Furthermore, the side walls may comprise, in each case, at least one first interlocking element and the shell element may comprise at least two second interlocking elements which are complementary with respect to the first interlocking elements and can, in particular, be latched together with the first interlocking elements and which serve for connecting the side walls to the shell element. Alternatively or in addition, the step of the connection of the side walls to the shell element may be performed by means of thermoforming, in the case of which the first and second interlocking elements are deformed under the action of heat and placed in engagement with one another. A cohesive and/or positively locking connection can thus be produced by means of thermoforming.

### BRIEF DESCRIPTION OF THE DRAWINGS

Preferred exemplary embodiments of the invention will be discussed in more detail below on the basis of the appended schematic drawings, wherein

FIG. 1 shows a perspective front view of a luggage compartment installed in an aircraft cabin of an aircraft,

FIG. 2 shows an exploded illustration from the rear side of the luggage compartment shown in FIG. 1,

FIG. 3 shows an enlarged view of a reinforcement element embedded in a side wall of the luggage compartment shown in FIGS. 1 and 2,

FIG. 4 shows an enlarged cross-sectional view of a marginal region of a shell element of the luggage compartment shown in FIGS. 1 and 2,

FIGS. 5 to 7 show an enlarged cross-sectional view of a connecting region between the side walls and the shell element of the luggage compartment shown in FIGS. 1 and 2 of a first to third embodiment, and

FIG. 8 shows a method step for producing a side wall of the luggage compartment shown in FIGS. 1 and 2.

### DETAILED DESCRIPTION OF THE PREFERRED EMBODIMENTS

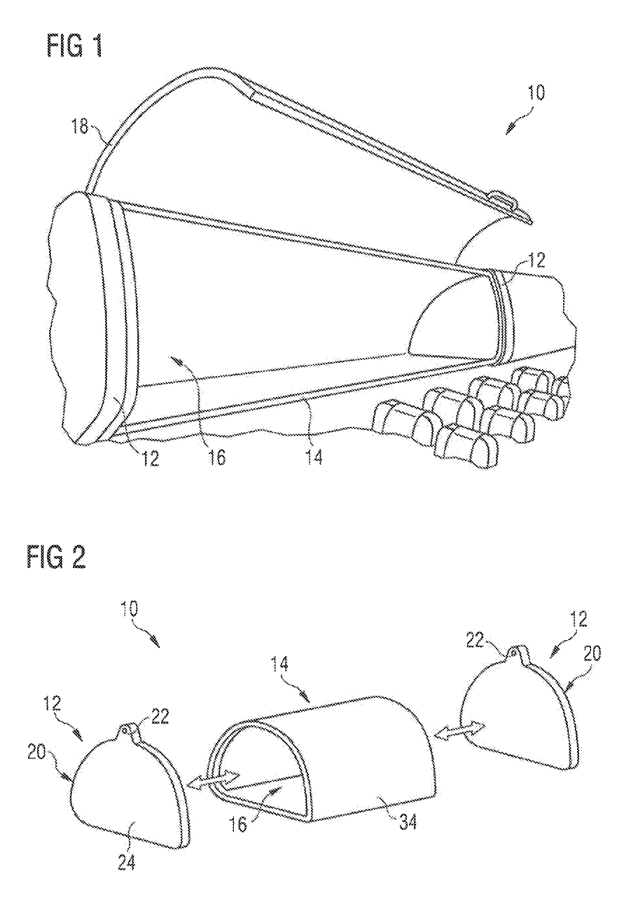

FIG. 1 shows a luggage compartment 10 for installation on the fuselage or ceiling in an aircraft, which luggage compartment is installed in a passenger cabin of an aircraft, above passenger seats. The luggage compartment 10 may alternatively also be installed in other vehicles, such as for example trains, buses, ships, etc. Behind and in front of the luggage compartment 10 in a longitudinal direction of the aircraft, there are arranged further luggage compartments which form a luggage compartment system composed of multiple luggage compartments 10. The luggage compartment 10 comprises two side walls 12 which are connected in load-bearing fashion to a primary structure of the aircraft, and a shell element 14 which is connected to the side walls 12. The side walls 12 and the shell element 14 define a stowage space 16 of the luggage compartment 10. For the loading and unloading of the stowage space 16, the shell element 14 is provided with an opening, by which the stowage space 16 of the luggage compartment 10 is accessible from the passenger cabin of the aircraft. The shell element 14 comprises a flap 18 which is movable between a closed and an open position and which serves for opening up and closing off the opening in the shell element 14.

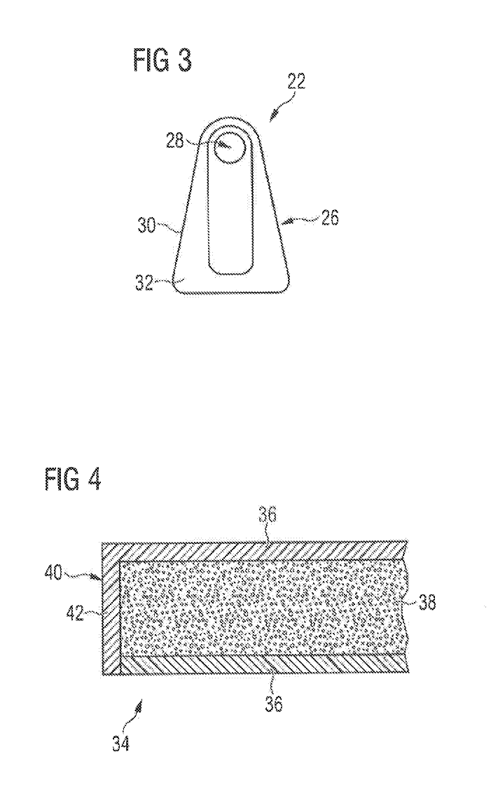

FIG. 2 shows the luggage compartment 10 in an exploded illustration from the rear side thereof. The side walls 12 have a fiber composite structure 20 which is produced from reinforced curable molding compound and which has a reinforcement element 22 embedded therein, which reinforcement element is connected to the primary structure of the aircraft when the luggage compartment 10 is in an installed state. An exemplary embodiment of the reinforcement element 22 is shown in FIG. 3, in a state not embedded or installed in the side walls. In the state embedded in the side wall 12, the reinforcement element 22 is connected in positively locking and/or cohesive fashion to the fiber composite structure 20 of the side wall 12. By virtue of the fact that the side walls 12 have the fiber composite structure 20 produced from reinforced curable molding compound, it is possible to easily produce side walls 12 of complex and arbitrary shapes which simultaneously permit simple configurability of the luggage compartment 10. Correspondingly, it is possible to produce side walls 12 with a load-optimized design and thus a lightweight construction. The side walls 12 are preferably equipped with stiffening ribs (not shown here) which are formed by the fiber composite structure 20. Here, the stiffening ribs are preferably arranged on a surface 24 of the side walls 12 which is not visible to a passenger from the passenger cabin. Furthermore, the stiffening ribs may be extended through by a further reinforcement element in the form of a plastic foam insert.

The fiber composite structure 20 of the side walls 12 which is produced from reinforced curable molding compound comprises reinforcement fibers in the form of chopped carbon fibers with a fiber length between 20 mm and 30 mm, in particular of 25 mm, and a plastic matrix composed of unsaturated polyester resin with an aluminum hydroxide additive as flame retardant. Specifically, the fiber composite structure 20 of the side walls 12 is produced from SMC semifinished parts as reinforced curable molding compound. Alternatively, the fiber composite structure 20 of the side walls 12 may be produced from BMC semifinished parts and/or from a thermoplastic molding compound with long reinforcement fibers.

The reinforcement element 22 shown in FIG. 3 comprises a first section 26 which is embedded in the fiber composite structure 20 of the side walls 12, and a second section 28 which is connected to the primary structure of the aircraft. The first section 26 is of substantially plate-like form and, in the mounted state 20 in the side wall 12, is received entirely in the side wall 12. The second section 28 connected thereto is provided in the form of an exposed receiving opening which, in the installed state of the luggage compartment 10, is connected to a complementary connecting element of the primary structure of the aircraft.

The reinforcement element 22 is, in the present case, provided in the form of a fiber composite component which is produced from a preform assembled from reinforcement fibers. The structure of the preform from which the reinforcement element 22 is produced is shown here in FIG. 3. Specifically, the preform is one produced by means of TFP methods, in the case of which rovings 30 assembled from endless fibers are sewn onto a base material 32 in accordance with the loading direction.

As shown in FIG. 2, the shell element 14 comprises a sandwich panel 34 which forms a housing main body of the luggage compartment 10. The flap 18 of the shell element 14 is preferably formed by a further sandwich panel. FIG. 4 shows a cross-sectional view of a marginal region of the sandwich panel 34 which comprises two surface layers 36 with a core layer 38 arranged in between. The core layer 38 is composed of an expanded polyetherimide foam. The core layer 38 is preferably produced by means of a foaming method in which the core layer 38 is produced between the surface layers 36 and is welded thereto. The surface layers 36 are composed of a fiber-reinforced plastic which includes reinforcement fibers composed of glass fibers and includes a plastic matrix composed of polyetherimide.

In an exposed marginal region of the sandwich panel 34, such as, for example, the marginal region that forms the opening in the shell element 14, the sandwich panel 34 comprises an edge structure 40 which encloses or closes off the core layer 38. In other words, the edge structure 40 prevents the core layer 38 from being visible to passengers from the passenger cabin in marginal regions of the sandwich panel 34. In the present case, the edge structure 40 is formed by a first of the two surface layers 36. Alternatively, the edge structure 40 may be formed by both of the surface layers 36. Specifically, the first surface layer 36 comprises a section 42 which projects beyond the core layer 38 and which forms the edge structure 40 and which is bent substantially through 90° and is connected to the other of the two surface layers 36. Thus, a substantially rectangular edge closure is produced in the exposed marginal regions of the sandwich panel 34. By means of the edge structure 40, an edge closure for the sandwich panel 34 can be provided in any desired form. For example, an edge structure 40 with rounded and/or beveled edges may be produced.

For the connection of the side walls 12 and of the shell element 14 to one another, the side walls 12 comprise, in each case, at least one first interlocking element 44, and the sandwich panel 34 of the shell element 14 comprises at least two second interlocking elements 46 which are complementary to the first interlocking elements 44 of the side walls 12, as shown in FIG. 5. The first interlocking element 44 is provided in the form of an interlocking means which extends, at least in sections, along an edge of the side walls 12. Specifically, the first interlocking element 44 is arranged on an encircling surface of the side walls 12. The first interlocking element 44 is preferably formed, in each case, by the fiber composite structure 20, though it may also be formed by a further reinforcement element. The second interlocking elements 46 are arranged in opposite marginal regions of the sandwich panel 34 which face toward, in each case, one of the side walls 12. Specifically, the second interlocking elements 46 are provided in the form of a groove which receives the first interlocking element 44. The first interlocking element 44 is, in this case, insertable into the second interlocking element 46 along a thickness direction of the sandwich panel 34. The second interlocking element 46 that forms the groove is formed, in particular, by the first surface layer 36 which comprises a section which projects beyond the core layer 38 and the second surface layer 36 and which, at a location spaced apart from the core layer 38, is bent through 90° such that a substantially U-shaped groove is formed.

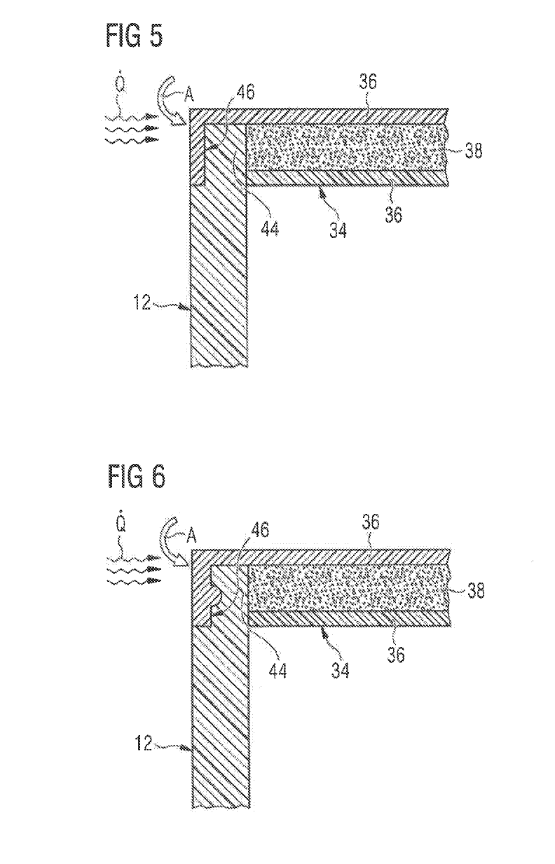

FIG. 6 shows a second embodiment of the first and second interlocking elements 44, 46 which, in relation to the embodiment shown in FIG. 5, are connectable to one another in latchable fashion. For this purpose, the first interlocking element 44 has a groove on a surface that faces toward the bent section of the first surface layer 36. Correspondingly, the second interlocking element 46 is equipped with a ridge which engages into the groove on the first interlocking element 44, on the bent section of the first surface layer 36.

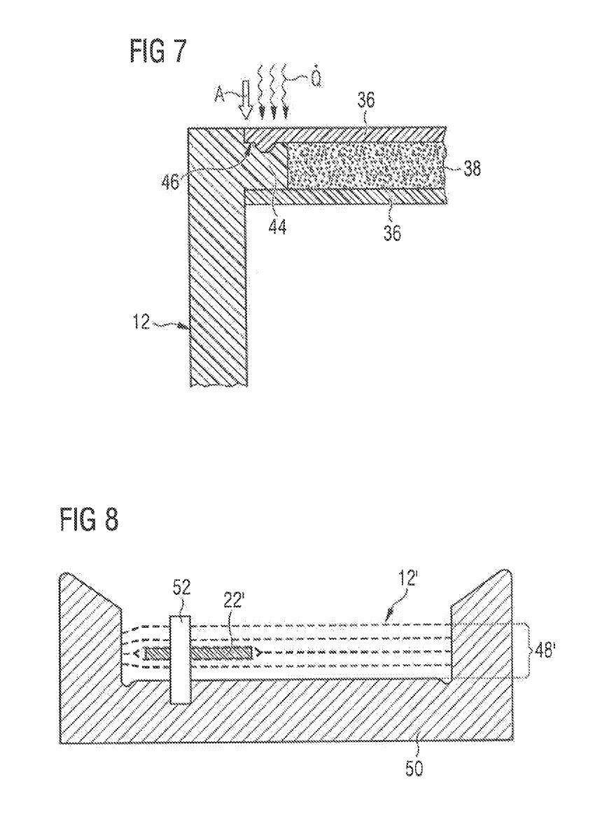

FIG. 7 shows a third embodiment of the first and second interlocking elements 44, 46, in the case of which, in relation to the embodiment shown in FIG. 6, the first interlocking element 44 is arranged on a lateral surface that adjoins the encircling surface of the side walls 12. Furthermore, in each case, the first and the second surface layer 36 have a section which projects beyond the core layer 38 and which form the second interlocking element 46 in the form of a groove. The first interlocking element 44 is, in this case, insertable into the second interlocking element 46 in a direction transverse to the thickness direction of the sandwich panel 34.

A method for producing the luggage compartment 10 described above will be specified below with reference to FIGS. 2 to 8. As shown in FIG. 8, in a first step of the method, at least two side wall semifinished parts 12′ composed of reinforced curable molding compound which comprise a curable plastic material in a non-cured state, are provided. The side wall semifinished parts 12′ are provided in the form of SMC semifinished parts 48′. Here, the side wall semifinished part 12′ for producing a side wall 12 comprises multiple coated SMC semifinished parts 48′ which are initially provided individually, are cut to size, and subsequently placed in layered fashion into a press mold 50 of an extrusion device. Alternatively, the side wall semifinished parts 12′ may be provided in the form of BMC semifinished parts and/or from a thermoplastic molding compound with long reinforcement fibers.

The method furthermore comprises a step of providing a reinforcement element semifinished part 22′ which is provided, in particular, in the form of a preform produced by means of TFP methods which preform includes a curable plastic material in a non-cured state.

In a next step, the reinforcement element semifinished part 22′ is, as shown in FIG. 8, inserted into the side wall semifinished part 12′. This is performed such that the reinforcement element semifinished part 22′ is embedded between layers of SMC semifinished parts 48′. Furthermore, a core 52 is inserted into the press mold 50, which core ensures the formation of a cavity in the finished side wall 12, by means of which cavity the reinforcement element 22 is connectable to the primary structure of the aircraft.

Subsequently, the curable plastic material included in the side wall semifinished parts 12′ and the curable plastic material included in the reinforcement element semifinished part 22′ are cured simultaneously, such that at least two side walls 12 that are connectable in load-transmitting fashion to a primary structure of the aircraft are produced. The side walls 12 thus produced have a fiber composite structure 20 produced from the reinforced curable molding compound in the form of the SMC semifinished parts 48′, into which fiber composite structure the reinforcement element 22 is at least partially embedded. Alternatively, instead of the reinforcement element semifinished part 22′, there may be inserted into the side wall 12 a reinforcement element 22 which remains in the side wall during the curing thereof. The curing is performed by means of extrusion, in the case of which the semifinished parts arranged in the press mold 50 are subjected to primary forming with an introduction of heat and pressure. Here, the press mold 50 preferably has a shape such that, by means of the extrusion, the first interlocking elements 44 arranged in the marginal regions of the side walls 12 are formed by the fiber composite structure 20.

The method furthermore comprises a step of providing the sandwich panel 34 of the shell element 14, in which step, firstly, the two surface layers 36 are provided and, subsequently, the core layer 38 is produced between the surface layers, and welded to the surface layers, by means of a foaming process.

Finally, the side walls 12 are connected to the shell element 14 that comprises the sandwich panel 34. For this purpose, the first interlocking elements 44 of the side walls 12 are placed in engagement with the second interlocking elements 46 of the sandwich panel 34. This is performed by means of thermoforming as shown in FIGS. 5 to 7. Specifically, during the thermoforming, an introduction of heat \dot{Q} into the first and second interlocking elements 44, 46 composed of thermoplastic material is performed which interlocking elements thus warm up and can thus be deformed. The first and second interlocking elements 44, 46 are thereupon deformed by application of a force in a desired direction A, such that a positively locking and/or cohesive connection between the first and the second interlocking element 44, 46 is produced.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A luggage compartment for installation on a fuselage or ceiling in a vehicle, which luggage compartment comprises:
at least two side walls connectable in load-bearing fashion to a primary structure of the vehicle and having a fiber composite structure, which structure is produced from reinforced curable molding compound and has at least one reinforcement element at least partially embedded therein, and
a shell element connected to the side walls and defining at least a part of a stowage space of the luggage compartment.

2. The luggage compartment as claimed in claim 1, in which the fiber composite structure of the side walls comprises reinforcement fibers composed of carbon or glass fibers, and comprises a plastic matrix.

3. The luggage compartment as claimed in claim 2, in which the reinforcement fibers are composed of chopped fibers in the form of carbon or glass long fibers.

4. The luggage compartment as claimed in claim 2, in which the plastic matrix comprises a thermoset material comprising at least one of an unsaturated polyester resin, or a flame retardant additive comprising aluminum hydroxide.

5. The luggage compartment as claimed in claim 1, in which the fiber composite structure of the side walls is produced from at least one of sheet molding compound semifinished products or bulk molding compound semifinished products.

6. The luggage compartment as claimed in claim 1, in which the at least one reinforcement element embedded into the fiber composite structure of the side walls is connectable in load-bearing fashion to the primary structure of the vehicle.

7. The luggage compartment as claimed in claim 1, in which the at least one reinforcement element is at least one of a plastic foam, composed of a thermoplastic material, or a fiber composite component produced from a preform assembled from endless reinforcement fibers placed in a tailored arrangement.

8. The luggage compartment as claimed in claim 1, in which the shell element comprises at least one sandwich panel constructed from two surface layers with a core layer arranged in between, which sandwich panel is connected to the at least two side walls, wherein at least one of
the core layer of the sandwich panel is composed of a plastic foam, or
the surface layers are composed of one of
a fiber-reinforced plastic which includes reinforcement fibers composed of glass fibers, or
a plastic matrix composed of a thermoplastic material.

9. The luggage compartment as claimed in claim 8, in which the core layer of the sandwich panel is composed of a polyetherimide thermoplastic foam or the surface layers are composed of polyetherimide thermoplastic material.

10. The luggage compartment as claimed in claim 8, in which the at least one sandwich panel comprises an edge structure enclosing the core layer and being formed by at least one of the surface layers.

11. The luggage compartment as claimed in claim 1, in which the side walls comprise, in each case, at least one first interlocking element and the shell element comprises at least two second interlocking elements complementary with respect to the first interlocking elements and which are latchable together with said first interlocking elements and which serve for connecting the side walls to the shell element.

12. The luggage compartment as claimed in claim 11, in which the first interlocking elements are formed by the fiber composite structure of the side walls or of a reinforcement element embedded therein, and the second interlocking elements are formed by the sandwich panel and by at least one of the surface layers of the sandwich panel.

13. A method for producing a luggage compartment for installation on a fuselage or ceiling in a vehicle, which method comprises the steps:
providing at least two side wall semifinished parts composed of reinforced curable molding compound and which include a curable plastic material in a non-cured state;
inserting at least one reinforcement element or at least one reinforcement element semifinished part into the side wall semifinished parts;
curing the curable plastic material included in the side wall semifinished parts to produce at least two side walls which are connectable in load-transmitting fashion to a primary structure of the vehicle and which have a fiber composite structure produced from the reinforced curable molding compound, into which fiber composite structure the reinforcement element is at least partially embedded; and
connecting the side walls to a shell element which defines at least a part of a stowage space of the luggage compartment.

14. The method as claimed in claim 13, in which the side wall semifinished parts composed of the reinforced curable molding compound comprise reinforcement fibers composed of carbon or glass fibers, and comprise a plastic matrix.

15. The method as claimed in claim 13, in which the side wall semifinished parts are provided from sheet molding compound semifinished parts or bulk molding compound semifinished parts, wherein the provision of a side wall semifinished part comprises the steps of providing at least one sheet molding compound semifinished part and cutting to size.

16. The method as claimed in claim 13, which furthermore comprises the steps:
providing the reinforcement element semifinished part as a preform assembled from reinforcement fibers by means of a tailored fiber placement method, which semifinished part includes a curable plastic material in a non-cured state; and
curing the plastic material included in the reinforcement element semifinished part to produce the reinforcement element.

17. The method as claimed in claim 13, in which the curing of the curable plastic material of the molding compound included in the side wall semifinished parts takes place at the same time as the curing of the curable plastic material included in the reinforcement element semifinished part.

18. The method as claimed in claim 13, in which the shell element comprises at least one sandwich panel with two surface layers and with a core layer arranged in between, wherein at least one of the core layer of the sandwich panel is composed of a plastic foam, or the surface layers are composed of at least one of a fiber-reinforced plastic which includes reinforcement fibers composed of glass fibers, or a plastic matrix composed of a thermoplastic material.

19. The method as claimed in claim 18, in which the core layer of the sandwich panel is composed of a polyetherimide thermoplastic foam or the surface layers are composed of polyetherimide thermoplastic material.

20. The method as claimed in claim 13, in which the side walls comprise in each case at least one first interlocking element and the shell element comprises at least two second interlocking elements, which are complementary with respect to the first interlocking elements and are latchable together with said first interlocking elements and which serve for connecting the side walls to the shell element, wherein the step of connecting the side walls to the shell element is performed by means of thermoforming.
